(19) United States
(12) Patent Application Publication
(10) Pub. No.: US 2023/0283019 A1
(43) Pub. Date: Sep. 7, 2023

(54) MEDIA-TIGHT CONNECTOR FOR USE BETWEEN SLEEVE AND HOUSING OF ELECTRICAL COUPLING

(71) Applicant: BELDEN DEUTSCHLAND GMBH, Schalksmühle (DE)

(72) Inventors: Othmar GAIDOSCH, Ostfildern (DE); Emrah EKICI, Stuttgart (DE); Carola HEIBER, Leinfelden-Echterdingen (DE); Nihat KARA, Walddorfhaeslach (DE)

(21) Appl. No.: 18/020,018

(22) PCT Filed: Sep. 10, 2021
(86) PCT No.: PCT/EP2021/074899

§ 371 Date: Feb. 6, 2023

(30) Foreign Application Priority Data
Sep. 18, 2020 (DE) 10 2020 124 406.1
Apr. 23, 2021 (DE) 10 2021 110 407.6

(51) Int. Cl. H01R 13/6581; H01R 13/52; H01R 13/622; H01R 13/6591

(52) U.S. Cl. CPC H01R 13/6581; H01R 13/5202; H01R 13/622; H01R 13/65912

(57) ABSTRACT

A connector (1, 2) having a jacket (1.3), a lock collar (1.1, 2.1), optionally additionally with a ring seal (2.2) and a shield sleeve (1.2) is proposed. The connector (1, 2) is preferably shielded. The connector (1, 2) includes a connection end for connecting an electrical line and a mating end for making a plug-in connection. Otherwise, the connector is mainly cylindrical and radially annularly closed. The jacket (1.3) is fixed at least partially around the shield sleeve (1.2), so that the jacket (1.3) is neither radially nor longitudinally movable relative to the shield sleeve (1.2). The lock collar (1.1, 2.1) is rotatable at least partially around the shield sleeve (1.2). The jacket (1.3) and the lock collar (1.1, 2.1) and/or the ring seal (2.2) overlap at least partially, with a seal being provided in the overlap region, which seal is of elastic design and is biased by the lock collar (1.1, 2.1) and/or the ring seal (2.2) toward the connection end.

The present invention relates to a connector having at least two parts and designed to be media-tight. In the following, media-tight means that no dirt or moisture can penetrate between the two parts of the connector.

For this purpose, the connector according to the invention can consist of a shield sleeve and a jacket. The connector is preferably designed as a line plug, i.e. for connection to an electrical line.

The overmolding of shielded cable connectors for field use is inevitably associated with the problem of ensuring media tightness between the jacket and the shield sleeve over the entire service life. The jacket is often made of plastic, and the shield sleeve is made of metal.

The poor chemical affinity between plastics and metals largely prevents such pairings from forming a material bond. Furthermore, plastic and metal have seriously different coefficients of expansion, which is also particularly disadvantageous in view of the wide temperature ranges in the field.

For these reasons, gaps form very easily at such mating surfaces, which in turn act as capillaries and lead to the penetration of media (water, coolants, oils, etc.) into the inner, functionally relevant connector region.

At present, media tightness on plastic-metal pairings is usually sought through additional processes, parts or other efforts that individually or in combination with each other result in correspondingly higher costs associated with:

Bonding agent or hot melt between the joining partners,

Plasma treatments of the joining partners,

Special process parameters,

Special additives in plastics,

Special coatings of the metal part, etc.

Thus, the object of the present invention is to achieve the required media tightness on shielded cable connectors directly, i.e. as far as possible without additional parts, processes or other efforts.

This object is attained by the features of the main claim.

For this purpose, a connector is proposed that has a jacket, a lock collar and a shield sleeve. The shield sleeve forms the inner part of the connector. In the assembled state, the jacket at least partially surrounds the shield sleeve.

Preferably, it is suggested that the jacket be an overmolded part of the shield sleeve. However, the jacket can of course also be designed as an independent component.

The connector further has a connection end and a mating end. An electrical line is connected to the connector on the connection end, and the mating end serves for plug-in connection with a suitable mating connector and is opposite the connection end.

On the mating end, the connector has a connection facility that can be operatively connected to the mating end of a suitable mating connector. The connector can be equipped with pins or sockets for this purpose. The suitable mating connector is then also equipped with pins or sockets, and the mating connector is equipped with the opposite mating option.

The jacket surrounds the shield sleeve in such a way that it is fixed against rotation and thus fixed relative to the shield sleeve. This can be achieved simply by overmolding the jacket onto the shield sleeve or by at least one flat on the shield sleeve in which the jacket can engage.

The lock collar also at least partially surrounds the shield sleeve, the lock collar being rotatable relative to the shield sleeve. The lock collar completes the jacket of the connector in such a way that the lock collar and jacket together extend a full length of the connector.

For better operation of the lock collar, it can be provided with a knurl that improves grip. The lock collar also has a fastener. This fastener can for example be designed as a thread.

The fastener of the lock collar can lock the connector to a suitable mating connector. For this purpose, the mating connector also has a corresponding fastener, in the case of the example of the thread, a suitable mating thread. For example, the connector can be equipped with a lock collar with an external thread and the mating connector with a locking nut with a complementary internal thread. When plugging the connector and mating connector together, the two threads can then engage with each other and lock the connector by turning the lock collar and/or nut.

According to the invention, the jacket and the lock collar are constructed such that they at least partially overlap. For example, the jacket can be formed such that the lock collar is at least partially fitted onto the jacket. The slide surface of the lock collar is then located partly in the region of the jacket partly in the region of the shield sleeve.

To create the desired media exclusion, a seal is now provided in the overlap region of the lock collar and jacket to protect the connector from the ingress of dirt and moisture.

According to the invention, the seal is designed to be elastic for this purpose and is biased toward the connection end during assembly when the lock collar is pushed onto the jacket.

For this purpose, for example, a tapered spring ring can be used that is placed on the jacket in a complementary groove and the lock collar is locked to the jacket via the spring ring during assembly. Alternatively, the spring ring can also be on the shield sleeve. The lock collar also has a groove in which the tapered spring ring engages and thus holds the lock collar axially in position.

The lock collar fitted in this way then radially compresses the seal during assembly by applying a force toward the connection end to the seal through the lock collar.

For this purpose, the seal can be designed as part of the jacket, as part of the lock collar or as a dedicated component positioned between the lock collar and the jacket.

According to the invention, the seal is biased during assembly and remains in the compressed state after assembly of the connector. As a result, forces are exerted on the seal that expand it radially at least in certain regions and thus reinforce the effect of the seal.

Like the jacket, the seal can also be overmolded or is preferably made of rubber.

If the seal and/or the jacket is an overmold, a rubber-like overmold compound can preferably be designed for this purpose in such a way that it is biased in a defined manner in the region relevant for sealing between two creep-resistant, preferably metallic surfaces.

It has proved particularly advantageous if the seal has a defined profile after compression. For this purpose, the seal itself can have ridges and/or grooves that are still present after compression. Alternatively, the jacket and/or the shield sleeve and/or the lock collar can also have complementary ridges and/or grooves in the region of the seal.

These webs or grooves ensure that the seal has a defined profile after compression and thus more effectively prevents the ingress of dirt or moisture. The fact that the defined profile creates different thicknesses of the seal results in different forces acting between the jacket and the shield sleeve when the seal is mounted. This different distribution of forces means that dirt or moisture penetrates the seal more slowly than would be the case with a seal with uniform force distribution.

In particular embodiments, the connector is provided with an electrical shield to protect the connector from interference fields and/or to increase EMC compatibility.

Furthermore, it is proposed to manufacture the seal from creep-resistant material in order to increase the service life of the seal as well as of the entire connector.

Further features are shown in the attached drawings. Therein:

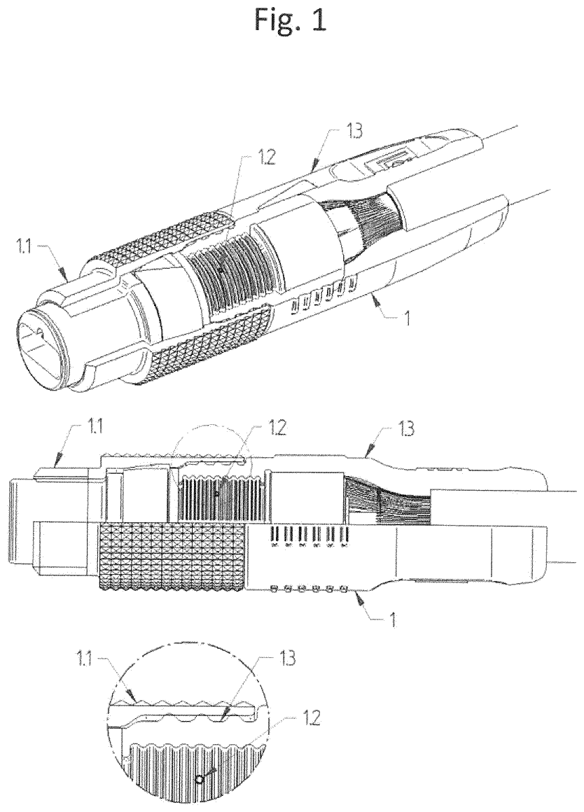

FIG. 1 is perspective views of an assembled connector with lock collar without seal ring,

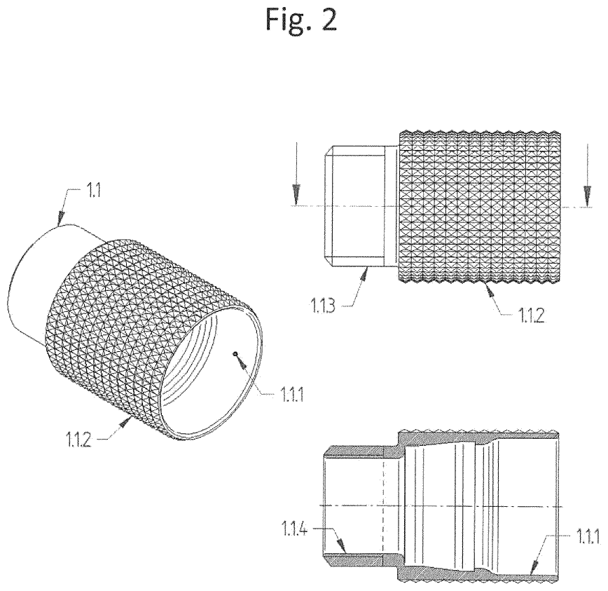

FIG. 2 is detail views of a lock collar,

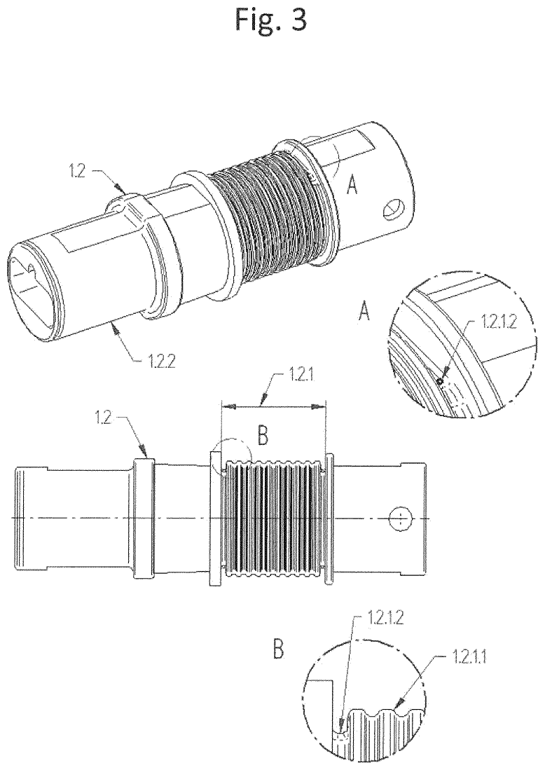

FIG. 3 is detail views of a shield sleeve,

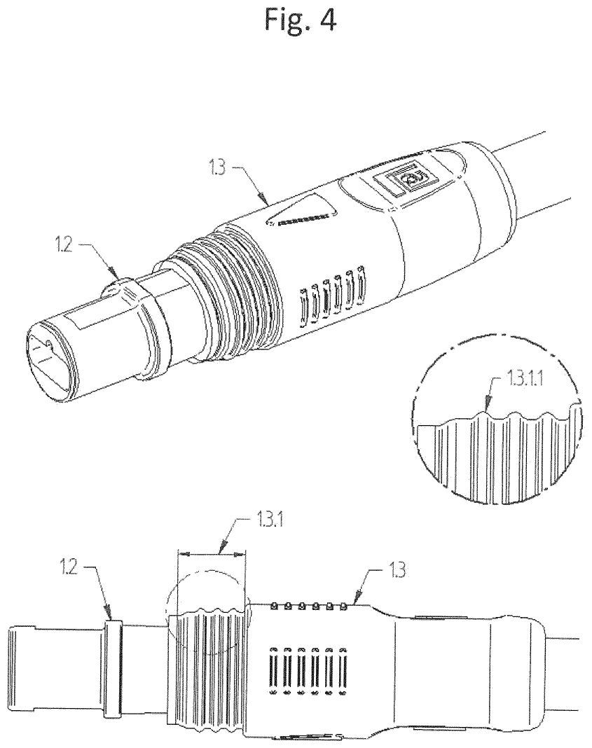

FIG. 4 is views of a shield sleeve with jacket,

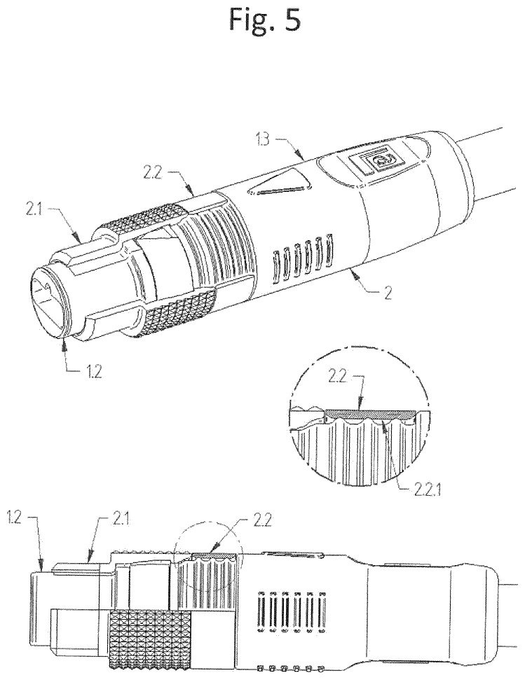

FIG. 5 is perspective views of an assembled connector, with lock collar and seal ring.

FIG. 1 shows an assembled and thus completed connector 1. This includes a lock collar 1.1, a shield sleeve 1.2 and a jacket 1.3.

The jacket 1.3 is preferably designed as an overmold and surrounds the shield sleeve 1.2 at least in certain regions. This means that the jacket 1.3 completely annularly surrounds the shield sleeve 1.2, but not along the entire length of the connector 1.

For this purpose, the jacket 1.3 is made of an elastomeric plastic. Also, the jacket 1.3 is electrically insulating. The jacket 1.3 is axially nonmovable relative to the shield sleeve 1.2 but is rotatable relative to the shield sleeve.

The connector 1 is elongated in shape and has two ends, namely a connection end and a mating end. The connector 1 is designed to be connected to a suitable mating connector, which is why contacts are provided on the mating end for establishing the plug-in connection. These contacts can be designed as pins or as sockets.

On the end of the connector 1 opposite the mating end is the connection end for coupling the connector 1 to an electrical line. This can be seen in FIG. 1 on the right-hand end of the connector 1.

The jacket is completed by the lock collar 1.1 that is pushed onto the shield sleeve 1.2 from the mating end when the connector 1 is assembled. For this purpose, means are provided that can hold the lock collar 1.1 axially in. FIG. 1 shows an spring ring for this purpose between the lock collar 1.1 and the shield sleeve 1.2. The spring ring is tapered and seated in a groove in the shield sleeve 1.2. The tapered outer surface of the spring ring allows the lock collar 1.1 to be pushed onto the connector 1 and locked in position on the connector 1.

The lock collar 1.1 is rotatable relative to the shield sleeve 1.2 and the jacket 1.3. The lock collar is also partially pushed over the jacket 1.3 when it is fitted onto the shield sleeve 1.2, so that the lock collar 1.1 and the jacket 1.3 at least partially axially overlap. This overlap can be seen in the circled region in FIG. 1.

A seal is formed in FIG. 1 from an portion region of the jacket 1.3 that can also be seen in the circled region. When the lock collar 1.1 is pushed onto the connector 1, the seal is prestressed, since pushing the lock collar 1.1 onto the connector 1 gives the seal less space than it would have without the application of force.

In order that the compression can be realized, the seal is elastic.

To improve the grip of the lock collar 1.1, it is provided with a knurling consisting of regular grooves and ridges. Furthermore, the lock collar 1.1 has means for fastening to a suitable counter screw. For this purpose, FIG. 1 shows an region that is provided with an external thread (region of reference mark 1.1). This allows the lock collar to engage with a suitable mating screw with a suitable internal thread and lock the plug-in connection. Of course, the lock collar can also be provided with an internal thread and the mating screw with an external thread.

This design offers the significant advantage that the lock collar 1.1 is frictionally secured against vibration without additional effort, on the one hand as a result of the increased release torque and on the other hand due to the good damping properties of the elastic seal.

FIG. 2 shows the lock collar 1.1 in detail. FIG. 2 shows two regions of the lock collar 1.1, namely the thread 1.1.3 and the knurl 1.1.2 for actuating the lock collar.

FIG. 2 also discloses the inner shape of an exemplary lock collar 1.1, in which a projection or groove can be seen for engaging the above-described spring ring during assembly, as well as a slide surface 1.1.4, for gripping the shield sleeve.

The lock collar 1.1 also has a jacket inner surface 1.1.1 that acts as a slide surface on and/or around the sealing region. The inner surface of the shell 1.1.1 can be smooth as shown or alternatively have grooves and ridges.

FIG. 3 shows an exemplary shield sleeve 1.2. This shield sleeve 1.2 is inside the connector. For this purpose, the shield sleeve 1.2 is annularly closed. The shield sleeve has a mating end (left in FIG. 3) and a mating end (right in FIG. 3).

A cable can be connected to the shield sleeve 1.2 via the connection end and a plug-in connection with a suitable mating connector can be established via the plug-in end.

The shield sleeve 1.2 in FIG. 3 has a surface region 1.2.1 that is provided with grooves and ridges and is thus ribbed. This design ensures a defined shape of the seal after compression to improve protection against dirt and moisture.

In addition to the surface region 1.2.1, at least one projection 1.2.1.1 is also disclosed in detail A, which on the one hand increases the distance that a penetrating medium must travel to reach the functionally relevant region. On the other hand, correspondingly higher normal forces are generated (when the seal is biased) on the inclined flanks of the projections due to the “wedge effect” that in turn has a positive influence on the sealing effect.

Detail B further shows a flat 1.2.1.2 that acts as an rotation-inhibiting formation between shield sleeve 1.2 and jacket.

FIG. 4 shows a connector comprising a jacket 1.3, but without the lock collar. The shield sleeve 1.2 and the jacket 1.3, which is preferably overmolded, can be seen again.

In this embodiment, the jacket 1.3 also includes a fluted region 1.3.1 with ridges and grooves (shown as projections 1.3.1.1) so this region 1.3.1 acts as a seal. The region 1.3.1 is thus compressed when the lock collar is fitted. The region 1.3.1 is elastic for this purpose.

The number of projections or grooves can vary depending on the material properties of the jacket 1.3 and the desired (actuation) torque on the lock collar. Of course, the region 1.3.1 can also be designed as an region without projections. In this case, the jacket 1.3 would have a cylindrical shape in region 1.3.1 with a corresponding oversize compared to the inner surface of the shell 1.1.1.

FIG. 5 again shows a completed connector 2, but with a different sealing configuration to FIG. 1. In addition, the connector includes a lock collar 2.1 that, however, has a shorter slide surface than the embodiment of FIG. 1.

FIG. 5 further discloses a jacket 1.3, corresponding to FIG. 1. This jacket can also be designed as an independent component or preferably as an overmolded part. The shield sleeve 1.2 already shown is also shown.

In contrast to the upset region of the jacket 1.3 that forms the seal here, a seal ring 2.2 is now shown. This is preferably made of a creep-resistant, metallic material.

When the lock collar 2.1 is fitted, the seal ring 2.2 is now positioned between the lock collar 2.1 and the jacket 1.3 in axial direction at the sealing surface. In this embodiment, the seal presses with it's the inner surface 2.2.1 of the seal ring 2.2. The lateral surface 2.2.1 can, as shown, be smooth, or alternatively also be designed with grooves and webs.

This embodiment can reduce the frictional effect when turning or actuating the lock collar 2.1 compared to the embodiment in FIG. 1, thus facilitating handling.

The invention is not limited to the above features. Rather, further embodiments are conceivable. For example, the jacket could be made of two different materials, with the sealing region of the jacket being made of a different material than the rest of the jacket. The lock collar could be designed as a locking nut and the connector could be designed male or female by using contact pins or contact sockets. Last, the seal could also be designed as a portion of the lock collar.

### REFERENCE LIST

1 Connector

1.1 Lock collar

1.1.1 Inner surface of the sheath of the lock collar

1.1.2 Knurl

1.1.3 Thread

1.1.4 Tread

1.2 Shield sleeve

1.2.1.1 Head start

1.2.1.2 Flat

1.3 Jacket

1.3.1 Sealing region

1.3.1.1 Bars and grooves

2 Connector

2.1 Lock collar

2.2 Seal ring

2.2.1 Inner surface of the seal ring

1. A connector comprising:
a jacket at least partially surrounding and fixed to the shield sleeve;
a shield sleeve;
a lock collar rotatable on and at least partially surrounding the shield sleeve, the lock collar and shield sleeve having a connection end for coupling to an electrical line and a mating end for making a plug-in connection, the jacket and the lock collar and/or a seal ring at least partially overlapping; and
a seal in the overlap region, elastic, and biased by the lock collar and/or the seal ring toward the connection end.

2. The connecter according to claim 1, wherein the seal is part of the jacket.

3. The connecter according to claim 1, wherein the seal is part of the lock collar and/or the seal ring.

4. The connecter according to claim 1, wherein the seal is annular seal and is positioned between lock collar and/or ring seal and jacket.

5. The connecter according to claim 1, wherein the jacket and/or the seal is an overmold.

6. The connecter according to claim 1, wherein the lock collar is a locking nut.

7. The connecter according to claim 1, wherein the lock collar is held in position by a spring and thereby the compression of the seal is permanently realized.

8. The connecter according to claim 1, wherein the lock collar and/or the ring seal has a jacket inner surface against which the seal rests in regions and through which the seal is biased.

9. The connecter according to claim 1, wherein the seal has webs and grooves to ensure defined compression.

10. The connecter according to claim 1, wherein the jacket and/or the lock collar and/or the ring seal has webs and grooves in the region of the seal in order to increase the effect of the seal.

11. The connecter according to claim 1, wherein the connector is provided with an electrical shield.

12. The connecter according to claim 1, wherein the seal is part of the jacket.

13. The connecter according to claim 1, wherein the seal is made of a creep-resistant material.

14. The connecter according to claim 1, wherein the lock collar is provided with a knurl for actuation.

15. The connecter according to claim 1, wherein the shield sleeve has at least one flat that ensures local strength.
